(19) United States
(12) Patent Application Publication
(10) Pub. No.: US 2010/0124849 A1
(43) Pub. Date: May 20, 2010

(54) Electrical Box

(75) Inventors: Nathan B. Winstanley, Lenox, MA (US); Brendan M. Walsh, Pittsfield, MA (US); Philip A. Cohen, Richmond, MA (US); Alilughatta Sathyanarayana Ashok, Kothrud (IN); Chandrakanthrao Gireeshrao, Cary, NC (US)

Correspondence Address: CANTOR COLBURN, LLP, 20 Church Street, 22nd Floor, Hartford, CT, 06103, US

(73) Assignee: SIGMA ELECTRIC MANUFACTURING CORPORATION, Garner, NC (US)

(21) Appl. No.: 12/620,271

(22) Filed: Nov. 17, 2009

Related U.S. Application Data
(60) Provisional application No. 61/115,305, filed on Nov. 17, 2008.

(51) Int. Cl. H01R 13/66; B23P 11/00

(52) U.S. Cl. 439/620.21; 29/428

(57) ABSTRACT

In one embodiment, an electrical box can comprise: a container formed from a base having sides extending therefrom to define a cavity; a cover configured to cover the cavity when in a closed position; and a female electrical connector disposed in the cavity when the cover is in the closed position. A socket of the female electrical connector can be capable of receiving a male electrical connector. Even when the electrical box is connected to live wiring, when the cover is in an open position, current cannot flow to the socket, and when the cover is in a closed position, current can flow to the socket. In another embodiment, an electrical box can comprise: a container; a cover configured to cover the cavity when in a closed position; and a female electrical connector physically connected to the cover such that the female electrical connector moves as the cover is opened.

### CROSS REFERENCE TO RELATED APPLICATION

This application claims priority to U.S. Provisional Application No. 61/115,305, filed on Nov. 17, 2008, which is incorporated herein in its entirety.

### BACKGROUND

The present application is directed to electrical boxes, and specifically to electrical boxes with an interruptible current flow.

Wiring boxes for containing electrical outlet connections are known and typically include a housing with one or more plug receptacles for insertion of standard electrical plugs based upon either the country and/or the voltage. Wiring entering an outlet box is typically connected to a particular electrical fixture or receptacle (female electrical connector) such as a lighting fixture, electrical outlet, or switch.

There have been many developments directed to the safety of the electrical outlet. For example, outlet cover(s) have been designed to be located over a receptacle such that a plug cannot be inserted through the cover into the receptacle without aligning the openings in the cover with the receptacle slots. Another safety product is a non-electrically conductive cap that can be inserted into the receptacle slot, thereby inhibiting the insertion of any other object. Even though these solutions have been somewhat effective. There remains a need for further improvements and alternatives in receptacle safety.

### BRIEF SUMMARY

Disclosed herein are electrical boxes, and methods of using the same.

In one embodiment, an electrical box can comprise: a container formed from a base having sides extending therefrom to define a cavity; a cover configured to cover the cavity when in a closed position; and a female electrical connector disposed in the cavity when the cover is in the closed position. A socket of the female electrical connector can be capable of receiving a male electrical connector. Even when the electrical box is connected to live wiring, when the cover is in an open position and the socket is accessible, current cannot flow to the socket, and when the cover is in a closed position, current can flow to the socket.

In one embodiment, a method of electrically inactivating an electrical box that is connected to live wiring, comprises: opening a cover of an electrical box that is connected to live wiring, wherein when the cover is open an electrical circuit between the wiring and a socket of a female electrical connector is open and the socket is electrically inactive; inserting a male electrical connector having a length of cord into the socket; and closing the cover.

In another embodiment, an electrical box can comprise: a container formed from a base having sides extending therefrom to define a cavity; a cover configured to cover the cavity when in a closed position; and a female electrical connector physically connected to the cover such that the female electrical connector moves as the cover is opened, wherein the female electrical connector is disposed in the cavity when the cover is in the closed position.

The disclosure can be understood more readily by reference to the following detailed description of the various features of the disclosure and the examples included therein.

### BRIEF DESCRIPTION OF THE DRAWINGS

Refer now to the figures, which are exemplary embodiments, and wherein the like elements are numbered alike.

FIG. 1 is a side view of an embodiment of the electrical box.

FIG. 2 is a side view of an embodiment of the electrical box.

FIG. 3 is a side view of the electrical box connected to the wall.

FIG. 4 is an exploded side view of the disassembled electrical box.

FIG. 5 is a side view of the assembled electrical box.

FIG. 6 is side view of an embodiment of a receptacle wherein the receptacle in the inactive position, so the socket is electrically inactive.

FIG. 7 is a side view of the receptacle of FIG. 6 being moved between the inactive and the active positions; e.g., the electrical circuit is being closed.

FIG. 8 is a side view of the electrical receptacle of FIG. 6, wherein the receptacle is in the active position; e.g., the electrical circuit is closed and the socket is electrically active.

FIG. 9 is a front view of an embodiment of the electrical box with an open cover.

FIG. 10 is a front view of an embodiment of the electrical box with a closed cover.

FIG. 11 is a front view of an embodiment of the electrical box with an open cover.

FIG. 12 is a front view of an embodiment of the electrical box with a closed cover.

FIGS. 13-14 are perspective, cut away, front and side views of an embodiment of the electrical box illustrating the employment of electrically conductive coiled wires.

FIGS. 15-18 are various perspective and side views of an embodiment of the electrical box illustrating an external switch.

### DETAILED DESCRIPTION

The electrical boxes described herein comprise current interruption which provides safety advantages therefore, i.e., the electrical socket can be electrically inactive when it is accessible for receiving a plug or other object and electrically active (“live”) when a plug is connected to the socket. Electrical boxes generally comprise a receptacle; i.e., a female electrical connector comprising slots in a socket for receiving and delivering current to prongs (also known as pins, blades, and the like) of an inserted plug. When in use, an electric plug (i.e., a male electrical connector comprising contact prongs that connect mechanically and electrically with the slots of the female electrical connector), is disposed in electrical and mechanical communication with the receptacle.

In various embodiments, the current interruption described herein refers to the female electrical connector (e.g., one or all sockets) being electrically inactive (e.g., not “hot”; electrically disconnected; “dead”) when the slots of the receptacle are accessible (e.g., the cover is open). For example, when the cover is open and the receptacle is accessible (e.g., able) to receive an electric plug, the receptacle is not live (i.e., no current can flow from the receptacle). For example, the socket does not become live until the cover to the junction box is closed, inhibiting removal of the plug from the socket. Additionally, a switch can be located on the outside of the cover further inhibiting electricity flow until the switch is turned to an on position.

In one embodiment, when a cover for an electrical junction box is in an open position, the plug receptacle is inactive, i.e., no electrical current is available; the socket is not in electrical communication with an electricity source. When the cover is in a closed position, the receptacle is active, thereby enabling the flow of electricity to the plug. Optionally, in the closed position, the cord and plug (e.g., the prongs of the plug) can be parallel to, and/or in line with, the electrical box base (see FIG. 3), thereby decreasing the electrical box side profile at least by the width of the plug and the cord as compared to the plug being in a perpendicular position to the electrical box base.

In this embodiment, when the cover is in an open position, no electricity flows to the receptacle. This feature ensures that when the user is inserting an object into the receptacle, the receptacle is inactive; no electricity can flow through the receptacle into the object. In order to enable electrical connection between the junction box and the plug and cord, the plug is inserted into the receptacle, the cover is closed, enabling the electrical connection and allowing electricity to flow to the socket and therefore, through the plug and cord. The connection enabling/disabling the electrical connectivity (e.g., electrically enabling/disabling the socket and/or the whole receptacle) can be accomplished via a switch, the receptacle and/or the cover. For example, the electrical box can comprise a switch that is on an exterior surface, accessible when the lid is in the closed position. This switch can enable and disable the flow of electricity to the receptacle and hence the plug. Such an arrangement would enable one to turn on/off all appliances (e.g., radio, temporary light, exterior device) receiving power from the electrical box, without removing the plug or using a switch on each appliance.

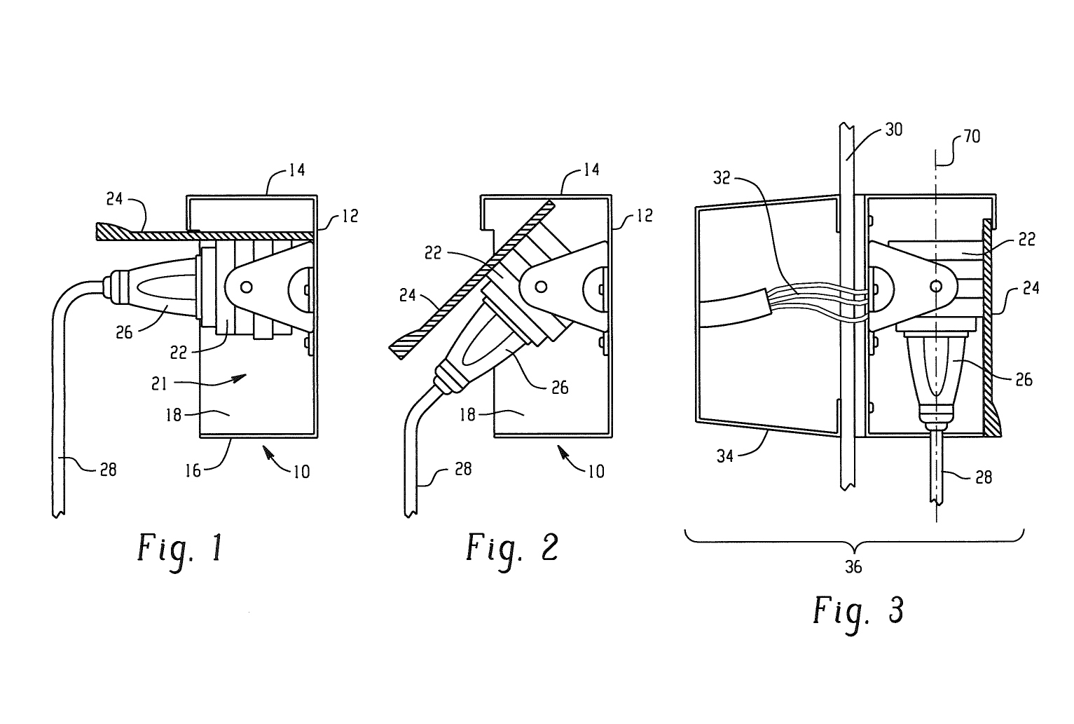

A first embodiment is shown in FIGS. 1-3 comprising a base 10 having a rear section 12, a first side 14, a second side 16, a third side 18, and a fourth side (not shown) that define a perimeter, forming cavity 21. A cover 24 operably communicates with the base 10. Optionally, the receptacle 22 can be hingedly connected to the cover 24 so that when the cover 24 is in an open position (FIG. 1), the receptacle 22 is electrically inactive and no electricity can flow to the receptacle 22. The receptacle 22 is located in the cavity 21 of the base 10. A plug 26 having a cord 28 can be inserted into the receptacle 22 when the cover 24 is in an open position. Optionally, the plug 26 and cord 28 can be perpendicular to the electrical box 10 when the cover 24 is in an open position. When the cover 24 is closed, the receptacle 22 becomes active and electricity can flow to the receptacle 22 and plug 26 (FIG. 3).

FIG. 2 illustrates an embodiment when the cover 24 is in the process of being closed. The receptacle 22 is still inactive until the cover 24 is closed. Once closed, the receptacle is electrically connected to a power source. Activating the receptacle can be accomplished in various fashions such as: (i) as the cover 24 closes, electrical contacts on the receptacle and box come into contact with one another, wherein when the cover opens, the receptacle contact moves out of contact with the box contact; (ii) once the cover is closed, a switch on the cover, base, or box, can be moved to the “on” position, wherein, when the cover is open, the switch automatically moves to the off position, the “on” position is disabled, and/or the box cannot be opened if the switch is in the “on” position (i.e., when electricity can flow to the receptacle and a plug located therein); and/or (iii) the receptacle remains stationary with respect to the cover, and when the cover opens, a non-electrically conductive component (e.g., dielectric shim), disrupts the electrical connectivity between the socket(s) and the wiring (e.g., the component moves between the contacts).

In some embodiments, as is illustrated in FIG. 3, once the cover 24 is closed, the plug 26 and cord 28 are parallel with the electrical box, thus creating a decreased side profile. In other words, the cord exiting and the box are in a common axis 70 with the receptacle slots (e.g., as opposed to being substantially perpendicular as is generally the case with while-in-use covers). In the embodiments where the receptacle 22 is pivotably engaged with base 12, as well as other embodiments, the side 16 can have an opening that is large enough to enable the cord to pass therethrough, yet too small to allow the plug to pass therethrough.

Within the electrical box can be standard and/or custom wiring connections, outlet connectors, and/or switches. For example, the electrical box can have a 110 volt, two pronged, non-grounded or two prong, three hole, grounded outlet, which can have multiple receptacles (e.g., located side by side), within the box or 220 volt outlet receptacle(s). It is noted that although the figures are illustrated with a standard three prong plug and associated socket, the present concept applies to any plug and socket configuration. For example, the present concept can be applied to sockets for alternating current and/or direct current, including those sockets fitting European, Asian, North American standards, as well as combinations comprising at least one of the foregoing and equivalents thereof. Some possible sockets and plugs include British Engineering Standards Association (BESA) plugs and sockets, National Electrical Manufacturers Association (NEMA) plugs and sockets, as well as other plugs and sockets, and combinations comprising at least one of the foregoing. Some examples include NEMA Type 1-Type 13, NEMA Type A-Type M, as well as combinations comprising at least one of the foregoing and equivalents thereof, e.g., IEC equivalents.

In FIG. 3, the electrical box 10 is attached to a wall 30 (e.g., building wall). Wires 32 are connected to the receptacle 22 through a container (e.g., electrical junction box) 34 mounted into the wall 30. The electrical box assembly 36 is shown with the cover 24 in a closed position such that the plug 26 and cord 28 are parallel with the side of the electrical box 10 and the receptacle 22 is active (i.e., electricity can flow through the electrical box 10 is a load is placed on the plug and cord; the plug 26 is in electrical communication with the wires 32).

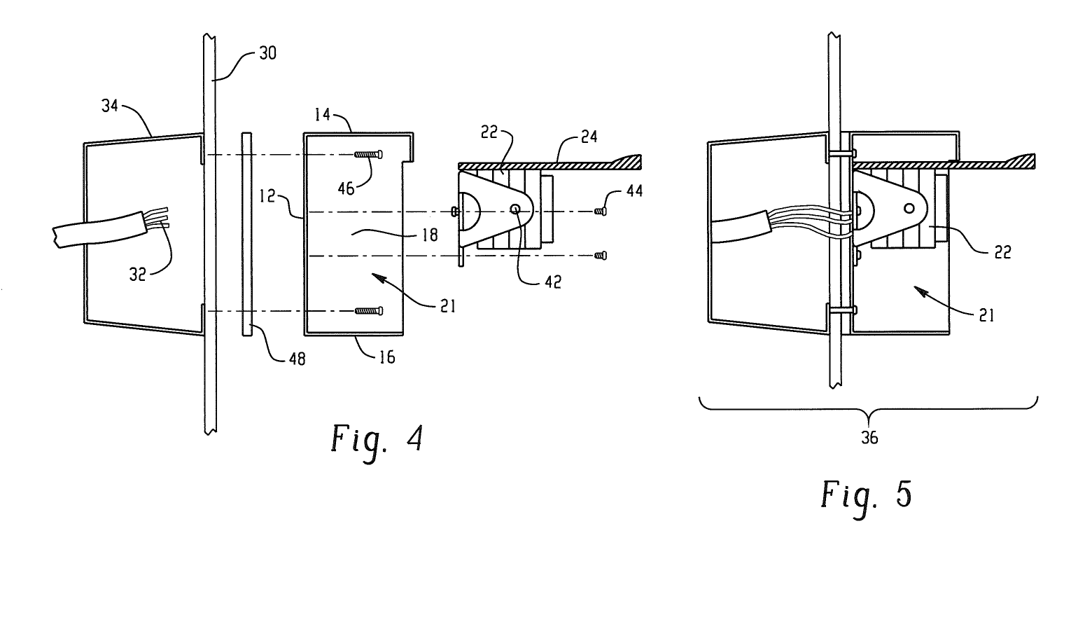

FIG. 4 provides an exploded view of the electrical box assembly 36 disassembled. The container 34 can be seen with the wires 32 passing therethrough. The container 34 is installed in a wall 30 awaiting the electrical box section defining a cavity 21. A clapboard spacer 48 can be located between the junction box 34 and the rear section 12 such that the base 10 can be mounted to the electrical box 34 via mounting screws 46. As can be seen, the receptacle 22 can be attached to the cover 24 such that the receptacle 22 and cover 24 can be hingedly attached to the base 10. The central point 42 on which the receptacle 22 rotates is also located in this region along with a pair of finishing screws 44. In FIG. 4, the cover 24 is open so that no electricity or current flows to the receptacle 22. FIG. 5 shows a fully assembled view of the electrical box 10 and the container 34 attached to the wall panel 30. In FIG. 5 the cover 24 is in an open position, meaning that no electricity is flowing to the receptacle 22.

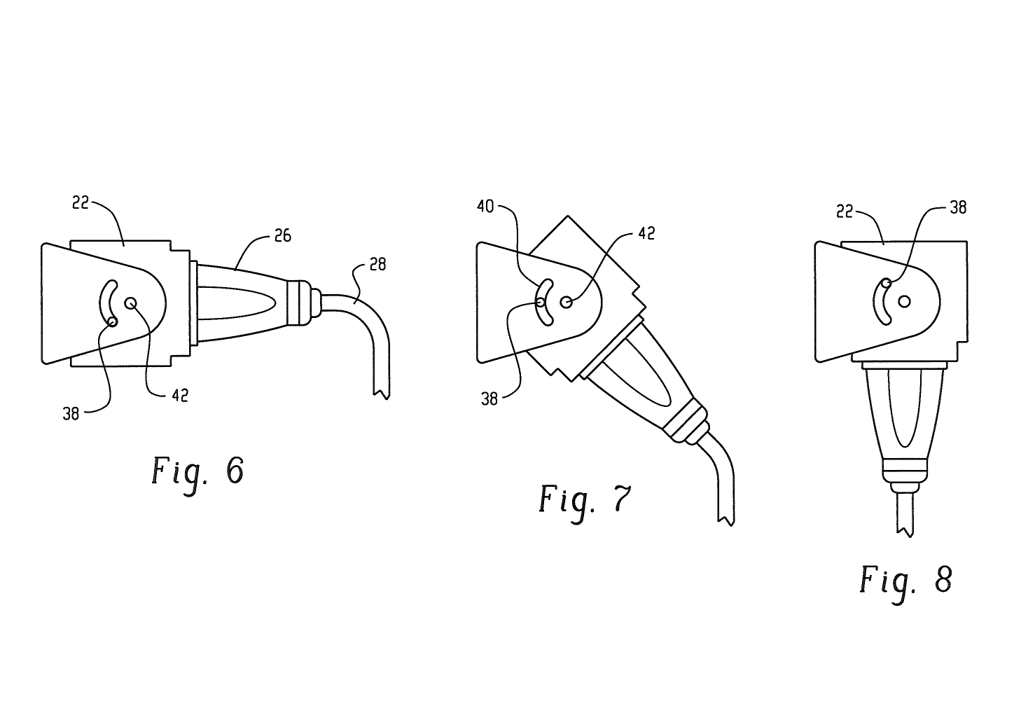

Turning now to FIGS. 6, 7, and 8, one embodiment of the operation of the receptacle is illustrated. In FIG. 6, the cover 24 (not shown) is in an open position with the plug 26 inserted into the receptacle 22 and fully engaged. In this position, no electricity is flowing to the receptacle 22 or plug 26. As shown in FIG. 6, a ball bearing 38 (e.g., a spring loaded ball bearing) is in a resting state, breaking electrical contact, and thus stopping current from flowing to the receptacle 22. FIG. 7 shows the receptacle 22 with the plug 26 inserted and fully engaged, and in motion, rotating on a central point 42 while the ball bearing 38 travels on a grooved path 40 in route to the activating position. FIG. 8 demonstrates the ball bearing 38 in place so as to establish electrical communication with the wiring and enabling the flow of current to the receptacle 22. In this position, the cover 24 closed (not shown) with the plug 26 and cord 28 fully rotated on the central point 42 and in parallel position with the side of the box. When the cover is reopened, the ball bearing 38 moves along groove 40, disengaging electrical communication between the receptacle and wiring and rendering the receptacle inactive.

In some embodiments, the receptacle is stationary and the cover moves independently of the receptacle. In these embodiments, the opening and closing of the cover can still disengage and engage, respectively, the electrical communication between the receptacle and the electricity source. For example, the cover can move independently of the receptacle (the receptacle remains in the cavity as the door opens). In other words, motion of an element of the electrical junction box assembly (e.g., the cover, cover assembly, receptacle, and/or another element of the outlet kit, can be employed to electrically activate and deactivate a receptacle; i.e., open and close the electrical circuit. The motion can be rotational and/or linear, e.g., sliding, such as, around, in/out, up/down, back/forth, as well as a combination comprising at least one of the foregoing motions, and can be in a direction appropriate for the particular electrical box assembly.

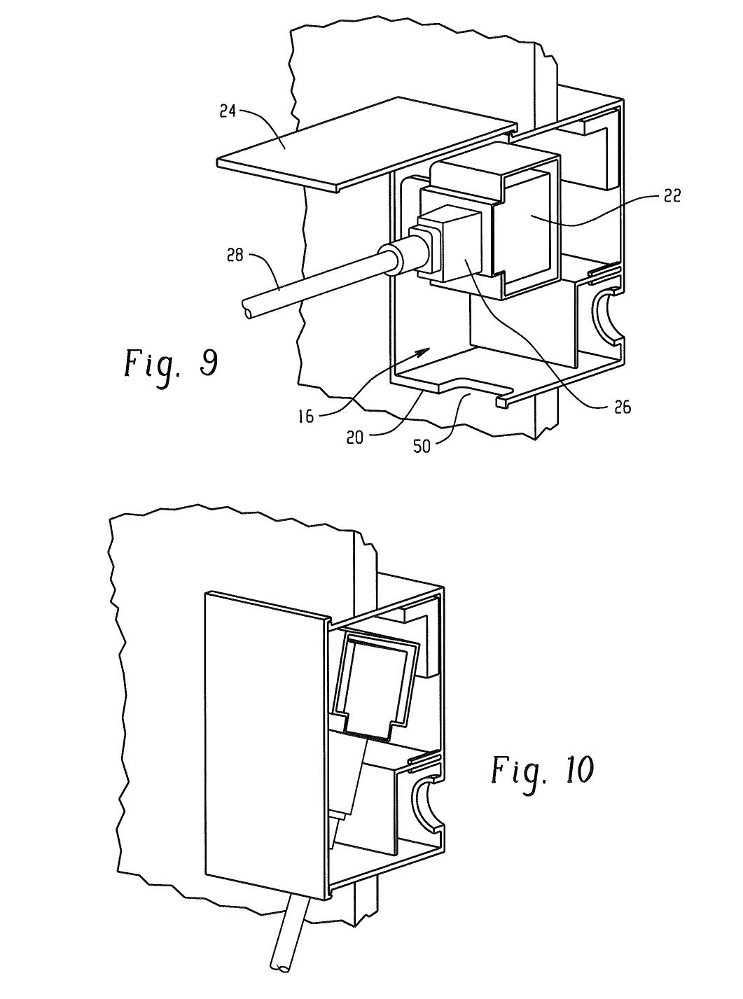

FIGS. 9 through 12 further illustrate embodiments of the electrical box 10. In FIG. 9, a receptacle 22 is shown with the plug 26 and cord 28 fully inserted. In FIG. 9, the cover 24 is open. As the cover 24 is closed, the receptacle 22 rotates with the plug 26 and cord 28 to one side and toward side 20 and opening 50 such that, in the closed position, the cord 28 passes through the opening 50. Once the cover 24 is closed, current can flow to the receptacle 22 such that power can be delivered via plug 26 and cord 28.

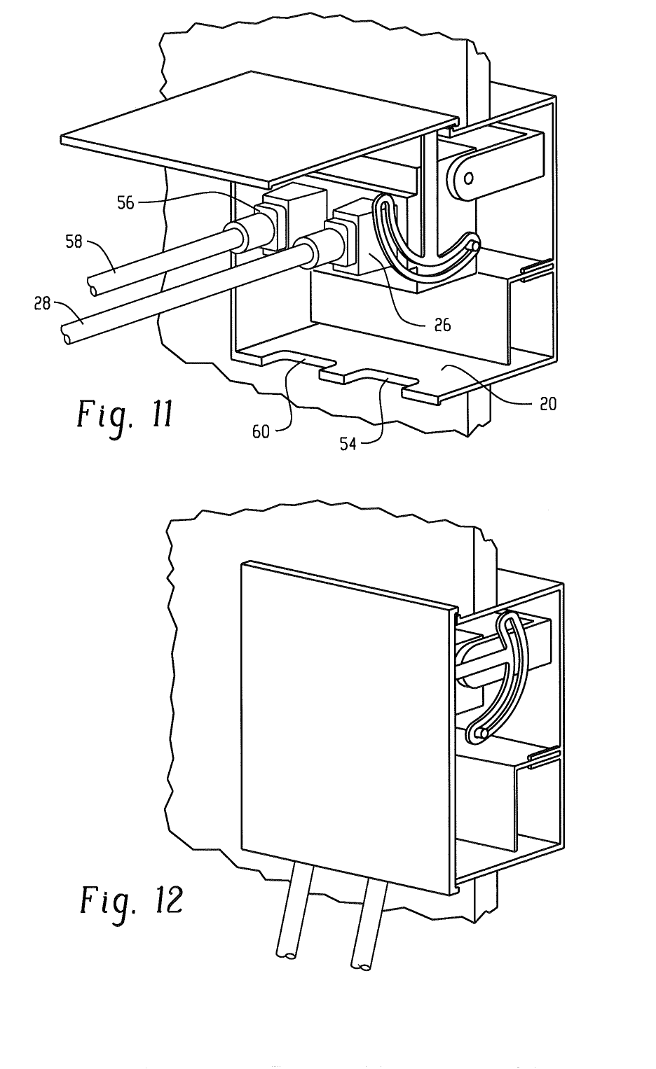

As shown in FIG. 11, in which a double receptacle 52 is illustrated, the electrical box can have one or more receptacles. FIG. 11 shows a receptacle 54 with plugs 26, 56 and cords 28, 58. As with FIG. 9, the cover 24 is open and multiple openings 54, 60 are located in side 20 of the electrical box. In FIG. 12, as the cover 24 is closed, the receptacle 22 rotates the plugs, 26, 56 and cords 28, 58 to one side and toward side 20. The cords 28, 58 engage with the openings 54, 60 in side 20. Once the cover 24 is closed, current flow to the receptacles. The cover 24 can be designed such that the fit between the cover 24 and the electrical box 10 is close enough to inhibit, and even prevent, water transmission into the electrical box 10 when the cover 24 is in a closed position as long as the electrical box is not partially or fully submerged in water.

The electrical box 10 can be mounted horizontally or vertically (e.g., if the electrical box is not square, the longest side of the box can be disposed vertically or horizontally). Additionally, one or multiple gang boxes are contemplated. It is further noted that the cover can open horizontally, vertically, or on an angle (e.g., diagonally), so long as the current flow to the receptacle(s) is ceased when the cover is in the open position and enabled when the cover is in the closed position (e.g., opening of the cover disrupts current flow to the receptacle(s) in the box). It is noted that it is also contemplated that the disruption in current flow is based upon the movement of the receptacle. For example, when the cover is opened, the spring loaded receptacle automatically moves to a disengaged position such that no electrical current flows the receptacle. In other embodiments, the receptacle(s) can be stationary and the cover (or an element associated with the cover) engages and disengages the electrical current (e.g., ceases the electrical communication with the socket(s) of the receptacle).

In one embodiment, the electrical box 10, including the base 12 and container 34, comprises a rigid formable material such as a cast metal (e.g., aluminum or other metal alloy) that is suitable for casting and allows for intricate details, strength, and conductivity (if required for the particular application being used). In another embodiment, the electrical box 10, including the base 12 and container 34 can be made of an injection moldable grade polymer. The injection moldable grade polymer may include a conductive filler or combination of electrically conductive fillers (if conductivity is required for the particular application being used) as well as fiber reinforcement if more structural strength (i.e., a stiffer part) is desired.

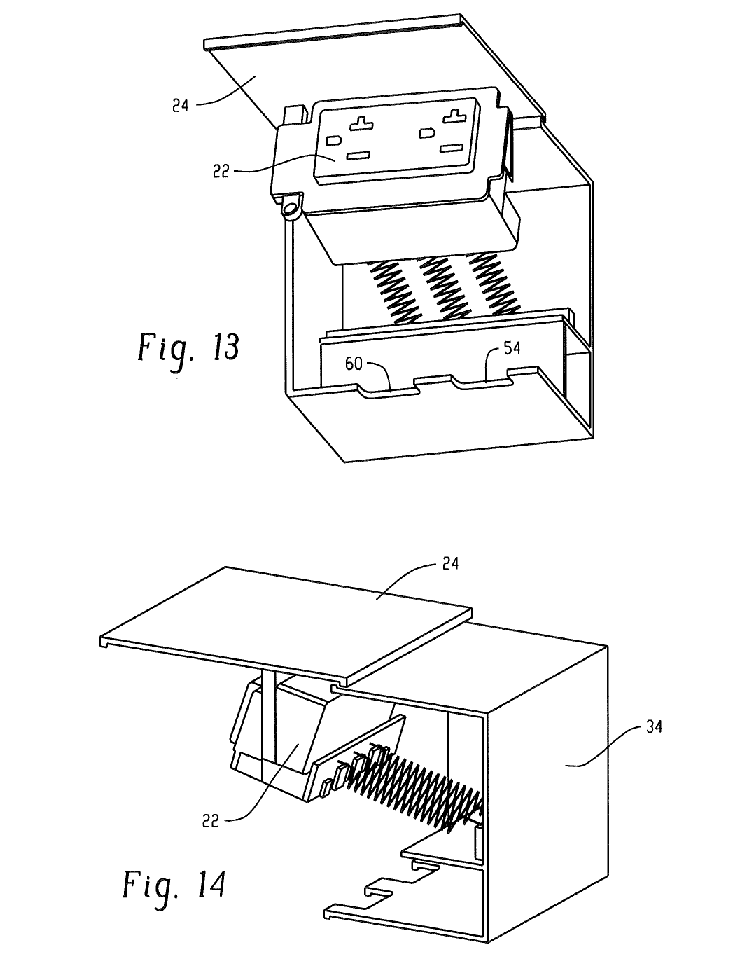

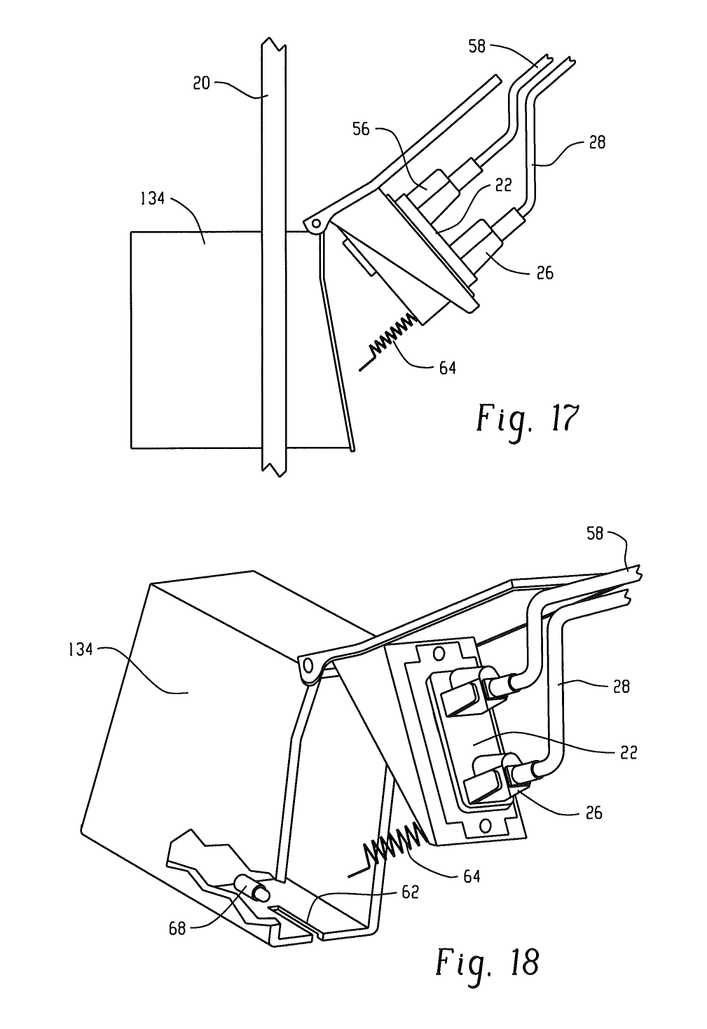

The embodiments illustrated in FIGS. 13-18 show different angles of an electrical box 134 wherein an electrically conductive wire 64 is connected to the receptacle. The wire 64 (e.g., a coiled wire) can sufficiently flexible and elastic (spring-like) to enable the cover 24 to be opened and the receptacle to move out of the box 134 without the need to disconnect wires. In this embodiment, the cover is pivotally connected directly to the junction box that can be inserted into the wall 20.

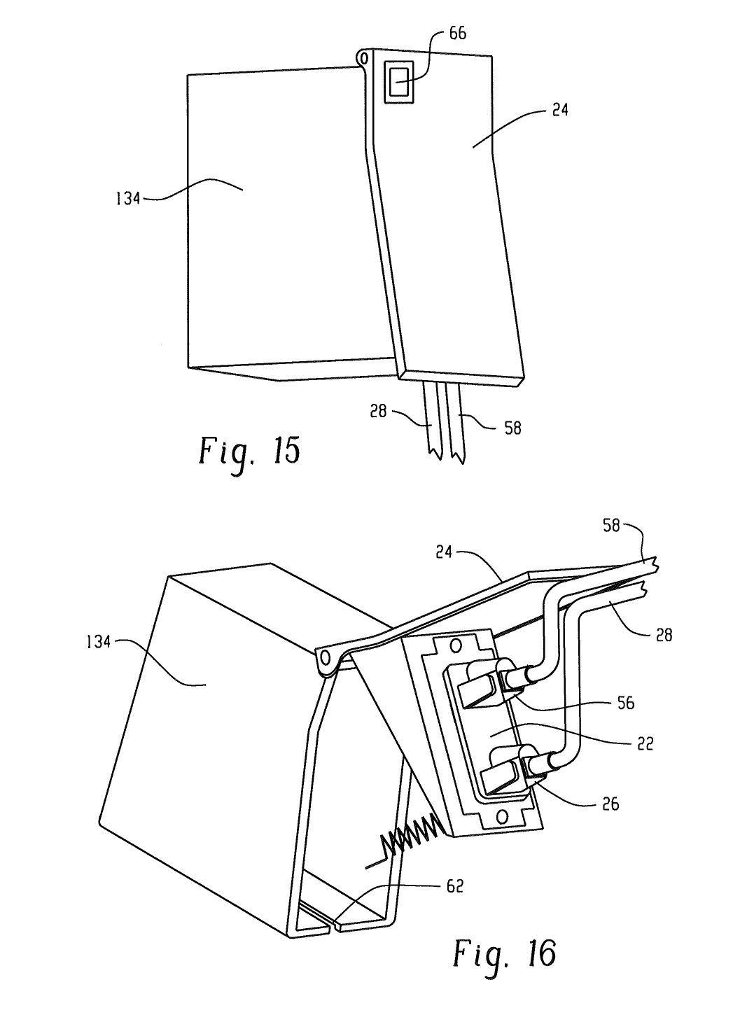

It is noted that the elements of the various embodiments can be combined and/or interchanged, so long as the combination does not adversely affect the functioning of the electrical box as intended. For example, the various switches, although discussed in separate embodiments, can be used alone or in combination. Also, the box can be designed such that multiple cords exit the box through a common opening 62 or separate openings 54, 60. In some embodiments, these openings can be designed to be sufficiently large to enable the cords to pass therethrough with the cover in the closed position, yet too small to enable the passage of a plug 26,56. The various embodiments can optionally comprise an external switch 66 on the junction box (see FIG. 15), e.g., a toggle switch, rocker switch, push button switch, rotary switch, snap-action switch, or the like, configured to switch the power to the receptacle and/or plug(s) on and off. Use of multiple external switches is also possible (e.g., two external switches), so that the power can separately be controlled to each socket (and hence each plug) without removing the plug from the receptacle. The various embodiments can also have contact(s) 68 that sense whether the cover is in the opened or closed position (e.g., a plunger contact that is depressed when the cover is closed).

The method of using these electrical outlets can comprise having an electrical box that is live, but the socket of the female electrical connector is dead (i.e., inactive) when the cover of the electrical box is in the open position. When the cover is closed, the socket(s) become electrically active (e.g., the electrical circuit is closed) and current can flow into the plug. Therefore, the method of providing electricity to a plug can comprise opening the cover of an electrical box. Inserting prongs of a male electrical connector (plug) into the socket of a female electrical connector (receptacle). Closing the cover such that the electrical circuit closes and the socket become electrically active.

“Combination” is inclusive of blends, mixtures, derivatives, alloys, reaction products, and so forth. Furthermore, the terms “first,” “second,” and so forth, herein do not denote any order, quantity, or importance, but rather are used to distinguish one element from another, and the terms “a” and “an” herein do not denote a limitation of quantity, but rather denote the presence of at least one of the referenced item. The suffix “(s)” as used herein is intended to include both the singular and the plural of the term that it modifies, thereby including one or more of that term (e.g., the receptacle(s) includes one or more receptacles). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and can or can not be present in other embodiments. In addition, it is to be understood that the described elements can be combined in any suitable manner in the various embodiments.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. An electrical box comprising:
a container formed from a base having sides extending therefrom to define a cavity;
a cover configured to cover the cavity when in a closed position; and
a female electrical connector disposed in the cavity when the cover is in the closed position, and wherein a socket of the female electrical connector is capable of receiving a male electrical connector;
wherein even when the electrical box is connected to live wiring, when the cover is in an open position and the socket is accessible, current cannot flow to the socket, and when the cover is in a closed position, current can flow to the socket.

2. The electrical box of claim 1, wherein the receptacle further comprises a spring loaded ball bearing, wherein when the spring loaded ball bearing is in a resting state, the socket is electrically inactive.

3. The electrical box of claim 2, wherein during opening and closing of the cover the spring loaded ball bearing traverses a path while the receptacle rotates on a central point.

4. The electrical box of claim 3, wherein when the electrical box is connected to live wiring, when the cover is in the closed position, spring loaded ball bearing establishes electrical communication between the wiring and the socket.

5. The electrical box of claim 1, further comprising an opening in the at least one of the sides, configured to allow a cord to pass from within the cavity to outside the box when the cover is in the closed position.

6. The electrical box of claim 1, wherein when the electrical box is installed in a wall, a plug is disposed in the receptacle, and the cover is closed, the electrical box protrudes from the wall a distance less than or equal to 7.0 centimeters.

7. The electrical box of claim 1, wherein the receptacle is attached to the cover such that when the cover is in an open position, the receptacle is outside the cavity.

8. The electrical box of claim 1, further comprising a switch on an external surface of the box, wherein the switch, in the off position, prevents current flow to the socket, and in the on position allows current flow to the socket.

9. The electrical box of claim 1, further comprising electrically conductive coil wire connected to the receptacle.

10. A method of electrically inactivating an electrical box that is connected to live wiring, comprising:
opening a cover of an electrical box that is connected to live wiring, wherein when the cover is open an electrical circuit between the wiring and a socket of a female electrical connector is open and the socket is electrically inactive;
inserting a male electrical connector having a length of cord into the socket; and
closing the cover.

11. The method of claim 10, wherein when the cover is closed, the electrical circuit is closed and current can flow to the socket.

11. The method of claim 10, wherein when the cover is in the closed position, the cord is parallel to a base of the box;

12. The method of claim 10, wherein the female electrical connector is physically attached to the cover such that it moves when the cover is opened.

13. The method of claim 10, further comprising moving a switch on an external surface of the electrical box to an on position to enable the socket to become electrically active, wherein, even if the switch is in the on position, if the cover is open, the socket is electrically inactive.

14. An electrical box, comprising:
a container formed from a base having sides extending therefrom to define a cavity;
a cover configured to cover the cavity when in a closed position; and
a female electrical connector physically connected to the cover such that the female electrical connector moves as the cover is opened, wherein the female electrical connector is disposed in the cavity when the cover is in the closed position.
